(19) United States
(12) Patent Application Publication
(10) Pub. No.: US 2011/0107255 A1
(43) Pub. Date: May 5, 2011

(54) Apparatus and method for providing list in portable terminal

(75) Inventor: Jeong Hoon Kim, Hwaseong-si (KR)

(73) Assignee: Samsung Electronics Co., Ltd., Suwon-si (KR)

(21) Appl. No.: 12/925,439

(22) Filed: Oct. 21, 2010

(30) Foreign Application Priority Data
Oct. 30, 2009 (KR) 10-2009-0104044

(51) Int. Cl. G06F 3/048

(52) U.S. Cl. 715/786

(57) ABSTRACT

A portable terminal can support a pop-up function capable of providing output information of an object focused on a list screen according to navigation execution. The portable terminal can output a list screen composed of a plurality of objects, extract output information of a specific object focused among the objects, and display the output information of the focused specific object on a pop-up window of the list screen.

### CROSS-REFERENCE TO RELATED APPLICATION(S) AND CLAIM OF PRIORITY

The present application is related to and claims the benefit of priority under 35 U.S.C. §119(a) to a Korean patent application filed in the Korean Intellectual Property Office on Oct. 30, 2009, and assigned Serial No. 10-2009-0104044, the entire disclosure of which is hereby incorporated by reference.

### TECHNICAL FIELD OF THE INVENTION

The present invention relates to a list providing method and a portable terminal supporting the same, and more particularly, to a list providing method facilitating convenience for a user upon managing objects constituting a list in a portable terminal, and a portable terminal supporting the same.

### BACKGROUND OF THE INVENTION

In general, a portable terminal has provided various list screens, for example, a call log list, a message list, and a phone book list. Further, in general, a memory of a current portable terminal includes a capacity exceeding Gigabytes. The number of objects stored in the portable terminal tends to be rapidly increased. Furthermore, as the number of the stored objects increases, the number of objects included in a list tends to be also increased. In this situation, it takes a long time and is inconvenient for a user to search a specific list and to manage objects in the list.

In particular, the number of users using message transmitting and receiving functions has recently been increased due to convenience thereof. As a use of the message transmitting and receiving functions is increased, the number of transmitting and receiving message contents, namely, objects corresponding to transmitting and receiving messages stored in a portable terminal has also been increased. The portable terminal stores objects with respect to transmitting and receiving messages integrally or by categories according to a supported storage capacity. Accordingly, the number of the objects constituting a message list can be increased to several thousand according to a storage capacity of the portable terminal. Meanwhile, an advertising spam message that a user does not need can be received as a receiving message.

Consequently, a user frequently performs works (deletion, movement, copy, or the like) managing transmitting and receiving objects included in the message list. In this case, conventionally, a user may select and confirm a corresponding object to check what contents in the message list include a specific object. In this case, a message function for confirming contents of a corresponding object is executed and the message list screen is changed to a message confirmation screen. Accordingly, the user confirms message contents of a corresponding object from the message confirmation screen to determine deletion, movement, copy, or maintenance. Further, to manage other objects, the user may close the message confirmation screen, and change to the message list screen to repeat the foregoing procedures with respect to the other objects, thereby managing a message list.

Meanwhile, a function capable of deleting objects constituting the message list is provided to the portable terminal. Such a delete function supports deleting respective objects one by one, simultaneous deletion of all message, or a scheme selectively designating a plurality of objects corresponding to a user's selection and selectively deleting only selected objects. A scheme deleting the objects one by one or a selective deleting scheme of the deleting schemes can perform a procedure confirming contents for deleting corresponding objects. However, a conventional portable terminal provides telephone information or the number of partially limited characters with respect to respective objects in a list or slides and provides a part of message contents by a slide function.

Accordingly, the user estimates total contents of a corresponding object based on a telephone number, a partially limited character, or partially slid contents or changes to the message confirmation screen to check total contents of the corresponding object and to determine presence or deletion thereof. Therefore, it is difficult and takes a long time to understand exact contents in managing a message list.

### SUMMARY OF THE INVENTION

To address the above-discussed deficiencies of the prior art, it is a primary object to provide a portable terminal supporting a pop-up function upon providing a list, and a list providing method using the same.

The present invention also provides a method that may efficiently manage objects in a list using a pop-up function, and an apparatus thereof.

The present invention further provides a list providing a method that may display output information with respect to respective objects in a list in a real-time manner by a pop-up function upon providing the list in a portable terminal, and a portable terminal supporting the same.

The present invention further provides a list providing a method that may provide output information of a focused object corresponding to user navigation through a pop-up window in a real-time manner upon providing a list, and a portable terminal supporting the same.

In accordance with an aspect of the present invention, a list providing method includes: outputting a list screen composed of a plurality of objects; extracting output information of a specific object focused among the objects; and displaying the output information of the focused specific object on a pop-up window of the list screen.

In accordance with another aspect of the present invention, a portable terminal includes: a display unit that displays a list composed of a plurality of objects, a focusing state of a specific object in the list, and output information of a focused object through a pop-up window; and a controller that focuses an object in the list, determines extraction of the output information of the focused object and a pop-up area of the pop-up window, and controls output of the pop-up window with the output information to the determined pop-up area.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a process for providing a list in a portable terminal supporting a pop-up function according to an exemplary embodiment of the present invention;

FIG. 2 illustrates a method for providing a list according to an exemplary embodiment of the present invention;

FIG. 3 illustrates a configuration of a portable terminal according to an exemplary embodiment of the present invention;

FIGS. 4 and 5 illustrate examples screens corresponding to a pop-up function execution in a portable terminal according to an exemplary embodiment of the present invention; and

FIG. 6 illustrates a pop-up window provided from a portable terminal according to another exemplary embodiment of the present invention.

### DETAILED DESCRIPTION OF THE INVENTION

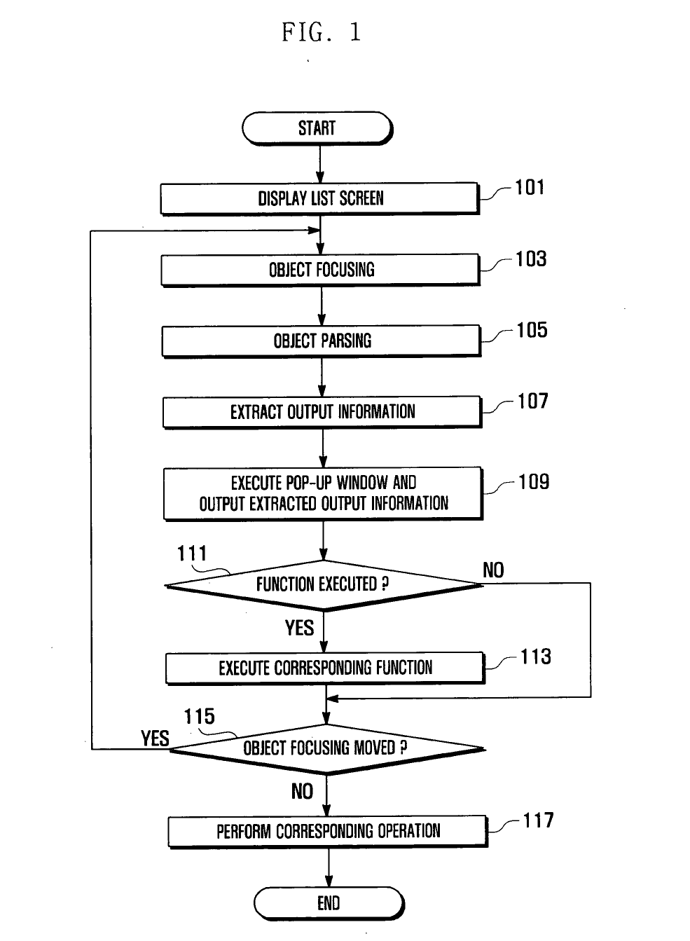

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication terminal. Detailed descriptions of well-known functions and structures incorporated herein may be omitted to avoid obscuring the subject matter of the present invention.

The present invention relates to a list providing method supporting a pop-up function, and an apparatus thereof. In particular, when a list of a specific category is provided, an embodiment of the present invention may provide output information with respect to objects constituting a corresponding list through a pop-up window in a real-time manner.

An embodiment of the present invention outputs a list screen corresponding to a user request, and provides output information of a corresponding focused object through a pop-up window in a real-time manner when focusing corresponding to a user's navigation execution moves in the list. Further, the pop-up window can be determined to locate a corresponding focused object to a position occupied in a screen of the list. Accordingly, the pop-up window can be adaptively provided to an upper area, a lower area, a left area, and a right area neighboring the corresponding object according to a location of the corresponding focused object.

Meanwhile, a list according to an embodiment of the present invention may include a call log list recording and providing received call particulars, transmitted call particulars, and message particulars, a phone book list providing user information and telephone numbers mapped thereto according to a user set, a first message list recording and providing received message particulars, a second message list recording and providing transmitted message particulars, and a third message list recording and providing received and transmitted message particulars. Hereinafter, a list is configured in multi-columns and one row as an example of a list according to the present invention. However, a list configured in one column and multi-rows, lattice pattern, namely, multi-columns and multi-rows can be provided.

Hereinafter, a portable terminal and a method for providing a list in the portable terminal supporting a pop-up function will be described. However, since the portable terminal and the list providing method of the present invention are not limited thereto, it is understood that they are applicable to various embodiments based on following embodiments.

FIG. 1 illustrates a process for providing a list in a portable terminal supporting a pop-up function according to an exemplary embodiment of the present invention.

Referring to FIG. 1, a portable terminal displays a specific list corresponding to a user request on a screen (block 101). The portable terminal extracts a specific list according to a user's list selection procedure and processes list screen display corresponding thereto. The list may be a list including an object such as a call log list, a message list, and a phone book list that has output information (for example, message text information, phone book information, or the like). The text information contains text contents of a message recorded according to transmitting or receiving of a message, and telephone number information. The phone book information contains a mobile communication telephone number, a wired telephone number, an electronic mail address, and a home address set by a user through a phone book function.

Next, the portable terminal may focus a specific object in the list on the list screen according to a user operation (block 103). Namely, a user may operate the portable terminal to display a screen of a desired list, and focus a specific object on the list screen.

Herein, the operation may be an operation generating an input signal using an input unit of the portable terminal or an operation generating a touch signal using a touch screen when the portable terminal includes the touch screen. Further, the focusing may be an operation designating a specific object by generating the input signal or a touch signal as mentioned above. Moreover, the focusing operation may become an operation automatically designating an upper most object of the list in an initial time when a list screen is displayed according to a set method of the portable terminal. In addition, the focusing may indicates a state that highlights a specific object or locates a cursor at the specific object.

Next, the portable terminal parses a specific focused object when the specific object is focused as described above (block 105). Then, the portable terminal may extract output information of the specific object by parsing the specific object (block 107). For example, assuming that the list is a message list in an example of FIG. 1, the portable terminal may extract text contents of a message among the output information with respect to the object and at least one text information among information such as phone numbers at block 107.

Subsequently, the portable terminal outputs a pop-up window at the time of extracting output information of the specific object, and outputs the output information on the output pop-up window (block 109). That is, the portable terminal displays the extracted output information through the pop-up window of the list screen. The portable terminal may provide output information of a specific focused object together with objects in the list.

Here, the portable terminal may perform a procedure producing a pop-up area outputting the pop-up window. Further, the portable terminal may determine the size and a shape of a pop-up window to be output at the pop-up area upon production of the pop-up area. Next, the portable terminal may output the pop-up window at the produced pop-up area and provide the output information through the output pop-up window. In this case, the pop-up window can be output at an upper side or a lower side of the selected object corresponding to the produced pop-up area. The shape of the pop-up window may be removed with a size determined according to the size of the output information. The pop-up window can be provided in a form including a scroll bar for scrolling output information. A detailed explanation thereof will be described below.

Next, the portable terminal may provide output information of the specific object through the pop-up window and check whether there is a function execution request (block 111). When there is the function execution request, the portable terminal can execute a corresponding function according to the user request (block 113). For example, the function execution may be function execution which selectively designates the specific object, executes a message function capable of confirming message contents when the specific object is an object of a message list, or deletes the specific object corresponding to the user request. Here, when the specific object is selected, an item such as “V” indicating selection of the specific object can be output at one side (for example, the leftmost area) thereof. An example of such a screen will be described below.

When there is no function execution request (No at block 111) or after a corresponding function is executed according to the user request at block 113, the portable terminal may check whether a focusing movement of the object occurs (block 115). When the focusing movement of the object occurs (Yes at block 115), the portable terminal proceeds to block 103 to move focusing in a direction corresponding to the user request to locate and display focusing at previous or next object of the previously focused object, and perform again following procedures.

Alternatively, when the focusing movement of the object does not occur (No at block 115, the portable terminal can perform a corresponding function requested from a user (block 117). For example, the portable terminal can execute a corresponding function according to the user request to delete, move, copy the object selected at block 113, or set a protection function thereof. Meanwhile, the portable terminal terminates display of the list screen to enter an upper menu, or transmits call as a corresponding function using the object according to the user request.

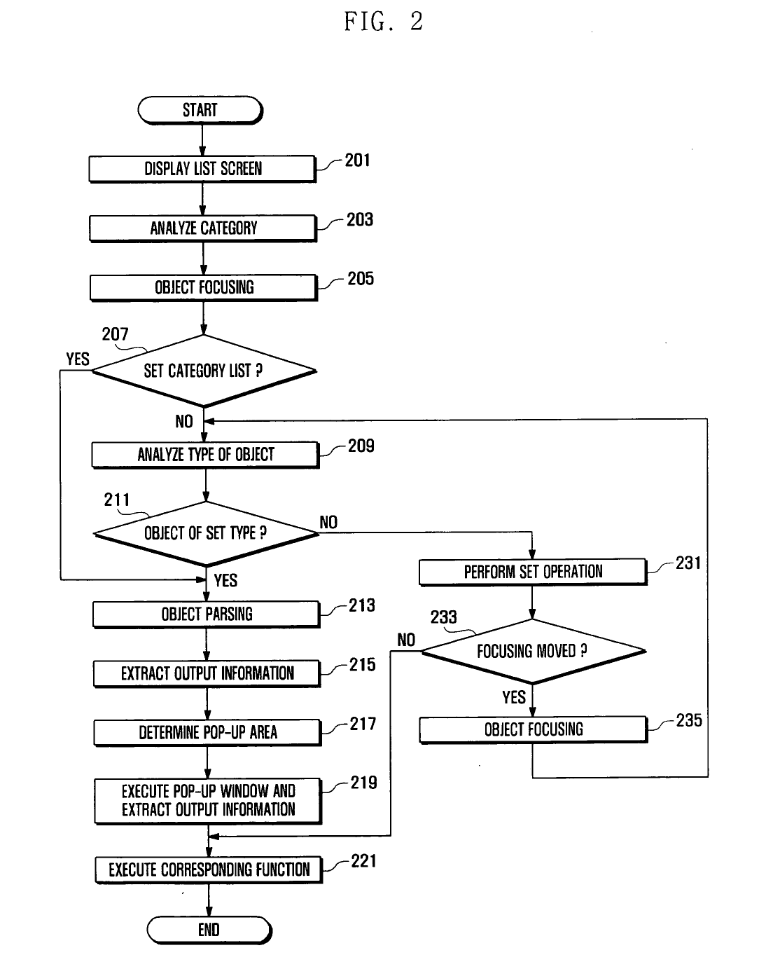

FIG. 2 illustrates a detailed operation example of a method for providing a list according to an exemplary embodiment of the present invention.

Referring to FIG. 2, the portable terminal displays a specific list corresponding to a user request on a screen (block 201). The list may be a list including an object that has output information (for example, message text information, phone book information, or the like) such as a call log list, a message list, and a phone book list. The text information contains text contents of a message recorded according to transmitting or receiving of a message, and telephone number information. The phone book information contains a mobile communication telephone number, a wired telephone number, an electronic mail address, and a home address set by a user through a phone book function.

Next, the portable terminal can analyze a category of the list upon displaying the list screen (block 203). For example, the portable terminal can analyze which category among various categories such as a call log category, a message category, and a phone book category does the list belongs to. At this time, the portable terminal may buffer the analyzed result information.

Next, the portable terminal may focus a specific objet in the list from a provided list screen according to a user operation (block 205). That is, the user may operate the portable terminal to control display of a screen of a desired list and perform an operation focusing the specific object on the list screen. Here, the operation may be an operation generating an input signal or a touch signal using an input unit or a touch screen of the portable terminal.

In this case, the portable terminal can focus the specific object according to the generated input signal/touch signal. Further, the portable terminal may automatically focus an uppermost object of the list or remove a focusing state in an initial time displaying a list screen according to a set manner. The focusing can indicate a state that enables the specific object to be highlighted or a cursor to be located at the specific object.

Next, the portable terminal may check whether the list with the object is a list belonging to a category to which the list is set using the result information analyzed at block 203 when the specific object is focused as described above (block 207). For example, the portable terminal discriminates whether the list belongs to a message category or a phone book category.

Namely, the portable terminal can discriminate whether the list is a message list or a phone book list. In a case of the message category or the phone book category, as all objects constituting a corresponding list (message list or phone book list) include text information or phone book information, the portable terminal may omit blocks 209 and 211 to be described below and directly go to block 213. Alternatively, in a case of the call log category, as objects constituting a corresponding list are composed of various types of objects such as call transmitting and receiving contents, message transmitting and receiving contents, and receiving contents on no answer, the portable terminal analyzes a type of a corresponding focused object to check whether or not it is an object capable of extracting output information (blocks 209 and 211).

Accordingly, when the list is a list belonging to a set category (for example, message list or phone book list) as the checking result of block 207 (Yes at block 207), the portable terminal goes to step 213 to be described below. Alternatively, when the list is a list not belonging to the set category (for example, call log list) as the checking result of block 207 (No at block 207), the portable terminal analyzes a type of the specific focused object (block 209), and checks whether the specific object is a set type of an object (block 211). For example, the portable terminal discriminates whether the specific focused object is an object of a message such as a receiving message or a transmitting message with output information.

Next, as the discriminating result of block 211, when the object is a set type of an object, for example, an object of a message type (Yes at block 211), the portable terminal parses the specific focused object (block 213). Further, the portable terminal extracts output information of the specific object by parsing the specific object (block 215). For example, when step 213 is directly performed after block 207, the portable terminal may extract text information or phone book information corresponding to a list of the set category.

When block 213 is performed after block 207 through blocks 209 and 211, the portable terminal may extract text information of a receiving message or a transmitting message according to the set type of an object.

Then, the portable terminal determines a pop-up area outputting a pop-up window upon extracting output information with respect to the specific object (block 217). Determination of the pop-up area can change on the list screen according to an existed position of the specific focused object. For example, the portable terminal can display the pop-up window at an upper area or a lower area of the specific object according to a position of the specific focused object. More particularly, when the specific object is located at a lower end based on a center of the list screen, the portable terminal may determine an upper area of the specific object as the pop-up area. Otherwise, when the specific object is located at an upper end based on the center of the list screen, the portable terminal may determine a lower area of the specific object as the pop-up area. At this time, an area neighboring an upper side or a lower side of a corresponding focused object can be determined as the pop-up area.

Subsequently, the portable terminal outputs the pop-up window at a pop-up area determined at the time of determining the pop-up area, and output the extracted output information through the pop-up window (block 219). For example, when the upper area of the specific object is determined as the pop-up area, the portable terminal may output the pop-up window at an upper area neighboring the specific object. Meanwhile when the lower area of the specific object is determined as the pop-up area, the portable terminal may output the pop-up window at a lower area neighboring the specific object.

Next, the portable terminal may output the pop-up window and output information of the specific object through the pop-up window and then execute a corresponding function requested from a user (block 221). For example, the portable terminal can execute a function of selecting the specific object and outputting an item such as “V” at one area of the specific object according the selection of the specific object in response to a user request. Further, the portable terminal may execute an edit function such as deleting, moving, and copying the specific object in response to the user request. Moreover, the portable terminal may execute a message function for confirming text contents of the specific object in response to the user request. In addition, the portable terminal can execute a procedure omitting display of the pop-up window upon execution of the corresponding function as mentioned above.

In the meantime, as the checking result of block 211, when the object is not an object of a set type, namely, a message type (No of block 211), the portable terminal may perform a set operation (block 231). For example, the portable terminal may slowly slide and provide partial information of the specific focused object (for example, title and partial contents of the specific object). In the meantime, the portable terminal may provide only a focusing state without obtaining any effects with respect to the specific object according to a set manner.

Next, the portable terminal can check whether focusing movement of the object is requested after performing the set operation (block 233). Namely, the portable terminal may control scroll according to a user's navigation execution, and move and provide a focusing state upward or downward according to an advance direction of navigation.

Next, when the focusing movement of the object is requested (Yes at block 233), the portable terminal may move focusing in a direction corresponding to the movement request and designate the focusing at an object existing at an upper side or a lower side of the specific object (block 235). Further, the portable terminal may perform block 211 after focusing the object and then perform following procedures. Alternatively, when the focusing movement of the object is not requested (No of block 233), the portable terminal may execute a corresponding function requested from the user (block 221). For example, the portable terminal can delete the specific focused object in response to the user request. Meanwhile, the portable terminal may execute a function terminating the foregoing list screen display and entering a menu corresponding to the user request or terminating a function of the portable terminal.

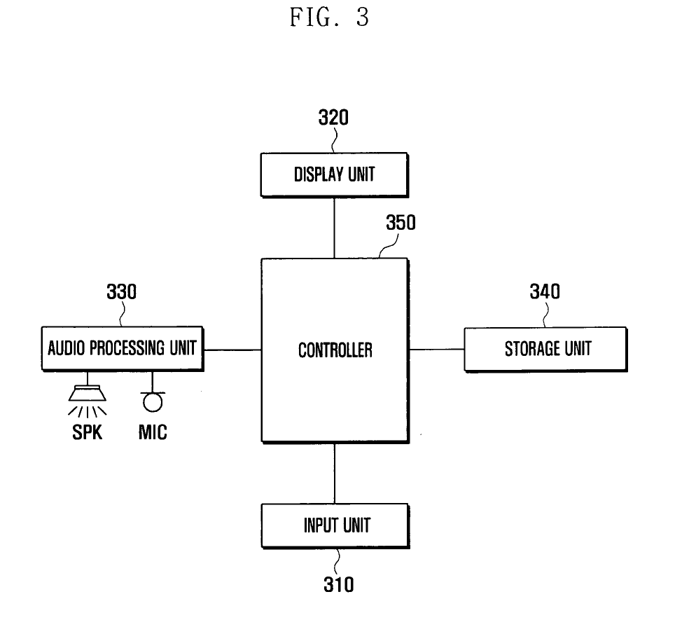

The following is an explanation of a pop-up function and a list providing method using the same so that a user may conveniently manage a list using output information provided at a pop-up window according to an embodiment of the present invention. A control operation of the portable terminal and a control operation of screen examples (FIGS. 3 through 6) to be described below according to the present invention is achieved by a controller 350 of the portable terminal or a software having a given algorithm for controlling the foregoing functions.

Hereinafter, a pop-up function and a configuration of the portable terminal supporting a list providing method according thereto are described. However, because a configuration of the portable terminal of the present invention is not limited to following techniques, it will be understood that the present invention is applicable to various embodiments based on following embodiments.

FIG. 3 illustrates a configuration of a portable terminal according to an exemplary embodiment of the present invention.

Referring to FIG. 3, a portable terminal of the present invention includes an input unit 310, a display unit 320, an audio processing unit 330, a storage unit 340, and a controller 350. The audio processing unit 330 may include a speaker SPK and a microphone MIC. The following is a detailed description of respective structures of the present invention.

The input unit 310 sends an input signal to input various numbers and character information, and an input signal associated with setting and control of respective functions of the portable terminal to the controller 350. The input unit 310 includes an input key that can input an input signal of the portable terminal and function keys. The function keys may include arrow keys, side keys, and hot keys set to execute specific functions. The input unit 310 can be configured by a touch pad, a touch screen, a key pad of general key arrangement, a Qwerty key pad, and a combination thereof according to a providing pattern of the portable terminal. In particular, the input unit 310 can generate and provide an input signal that controls navigation between objects in a list on a list screen of specific data, and an input signal that selects a specific object in the list to the controller 350. The input signal that controls the navigation can be generated in one of a key signal according to operation of the arrow key or a touch signal according to contact of the touch screen. The input signal that selects the object can be generated in one of a key signal according to operation of a function key (for example, confirmation key) allotted to the input unit 310 or a touch signal according to contact of the touch screen.

The display unit 320 outputs a screen activated according to function execution of the portable terminal. For example, the display unit 320 can output a boot screen, an idle screen, a menu screen, a list screen, a play screen, and the like. Namely, the display unit 320 can display all kinds of screens associated with a state and an operation of the portable terminal. A Liquid Crystal Display (LCD) or an Organic Light Emitting Diodes (OLED) is applicable as the display unit 320. Further, the display unit 320 can be implemented in a touch screen scheme. In this case, the display unit can simultaneously input and output functions.

When the display unit 302 is implemented by the touch screen to perform an input function, navigation control between objects and object selection control on a list screen can be achieved by a touch input. Namely, a user generates a touch input at an area in which a desired specific object is provided to control the navigation and selection. Further, the display unit 320 can provide a focusing state such as highlight display or cursor display to a corresponding object in one of an automatic designation or a user selection according to a set manner upon displaying the list screen.

Moreover, the display unit 320 can display a pop-up window at an area neighboring the specific focused object under the control of the controller 350 upon execution of a pop-up function. For example, the display unit 320 can display the pop-up window at an area determined by the controller 350 among a lower area, an upper area, an overlapped left area, and an overlapped right area. Furthermore, the display unit can display output information extracted and provided by the controller 350 in the pop-up window upon displaying the pop-up window.

The audio processing unit 330 can include a speaker SPK for playing an audio signal of the portable terminal and a microphone MIC that can collect an audio signal such as a user's voices. The audio processing unit 330 connects with the microphone MIC and the speaker SPK, and converts an audio signal received from the microphone MIC into data, and outputs the data to the controller 350. The audio processing unit 330 outputs an audio signal from the controller 350 through the speaker SPK. Namely, the audio processing unit 330 converts an analog audio signal from the microphone MIC into a digital signal, and outputs the digital signal to the controller 350. The audio processing unit 330 converts a digital audio signal from the controller 350 into an analog audio signal, and outputs the analog audio signal through the speaker SPK. Furthermore, the audio processing unit 330 can output various audio components (for example, audio signal for effect alarm according to output of pop-up window, audio signal according to data play, and audio signal for effect alarm at the time of object navigation) created in the portable terminal according to a user selection.

The storage unit 340 can be configured by a Read Only Memory (ROM) and a Random Access Memory (RAM). The storage unit 340 stores various data created and used in the portable terminal. The various data include data (for example, call log data, message data, phone book data, music data, image data, broadcast data, photograph data, or the like) created according to function execution of the portable terminal, all types of data capable of being stored by creating using the portable terminal or receiving from a peripheral device (for example, web server, external portable terminal, PC), and an application for directly executing corresponding function/menu set among support functions of the portable terminal.

The storage unit 340 may store software associated with pop-up function control. Further, the storage unit 340 may store various setting information according to a use of the portable terminal and the pop-up function. The various set information may contain size information of a pop-up window, pop-up area on which the pop-up window is displayed, and information with respect to presence of automatic focusing designation with respect to an uppermost object upon providing an initial list screen. Furthermore, the storage unit 340 may store a list composed of at least one object having output information.

In addition, the storage unit 340 may include at least one buffer temporarily storing data created during function execution of the portable terminal. For example, the storage unit 340 may execute a function buffering output information with respect to a specific object extracted upon operating the pop-up function. The storage unit 340 can be configured at an inside of the portable terminal or at an outside thereof like a smart card. The storage unit 340 may include all storage media at inside/output of the portable terminal. The storage unit 340 may include RAM, ROM, and a flash Memory. The storage unit can be configured by one of RAM, ROM, and a flash Memory, or one or two integrated memories, for example, a multi chip package (MCP) memory.

The controller 350 performs overall control functions with respect to the portable terminal, and controls signal flow between respective constructions in the portable terminal. The controller 350 controls signal flow between structural elements such as the input unit 310, the display unit 320, the audio processing unit 330, and the storage unit 340.

The controller 350 controls a pop-up function of the present invention and a list providing function using the pop-up function. The controller 350 controls the display unit 320 to display a list corresponding to a user request. Further, when the specific object is focused in the list, the controller 350 extracts output information with respect to the specific object and determines a pop-up area of a pop-up window outputting the output information. Moreover, the controller 350 outputs a pop-up window at the determined pop-up area, and controls display of the output information in the output pop-up window. When a given time elapses after outputting the pop-up window or when focusing moves, the controller 350 controls the removal of the output pop-up window. Furthermore, the controller 350 may determine the size and the shape of the pop-up window provided upon operating the pop-up function. The controller 350 controls functions such as navigation, selection of a specific object, and focusing movement corresponding to a user request upon management of a list by the pop-up function.

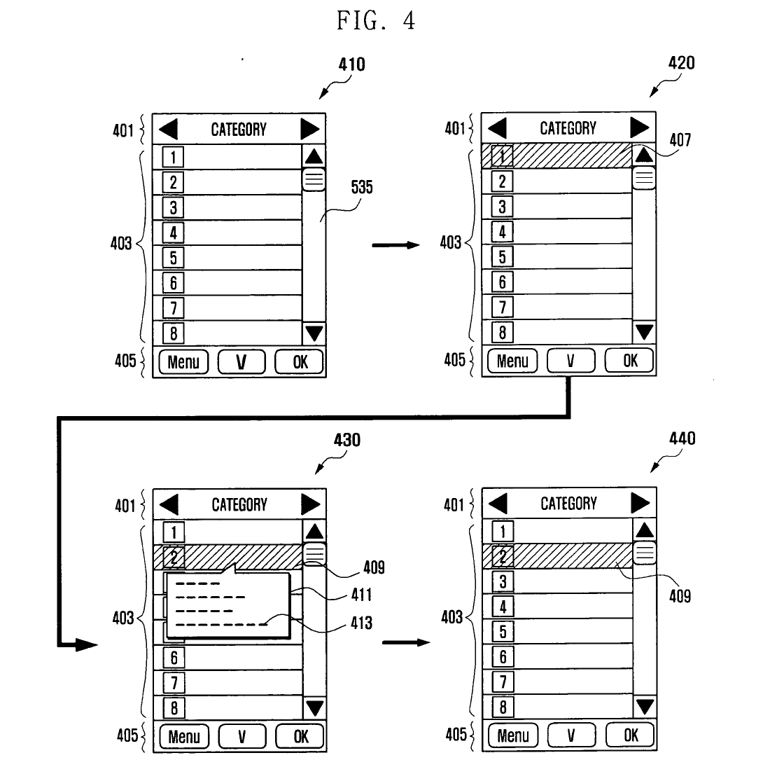

The controller 350 controls overall operation and functions thereof associated with a pop-up function operation of the present invention with reference FIG. 1, FIG. 2, FIGS. 4 to 6 to be described below. Further, as mentioned above, a series of control functions of the controller 350 may be implemented and provided by software.

Meanwhile, FIG. 3 shows a schematic configuration of the portable terminal for convenience of a description by way of example. However, the portable terminal of the present invention is not limited to the foregoing configuration. Accordingly, the controller 350 may include a baseband module for mobile communication service of the portable terminal, and the portable terminal may further include a wireless communication module corresponding thereto. The baseband module may be included in each or one of the controller 350 and the wireless communication module.

Furthermore, although not shown in FIG. 3, the portable terminal of the present invention may include a near distance communication module for near distance communication, a camera module photographing still/moving images of a subject, an interface unit for performing data transmission and reception by a wired communication scheme and a wireless communication scheme of the portable terminal, an Internet communication module communicating with an Internet to perform an Internet function, and a digital broadcast module performing digital broadcast receiving and playing functions besides the foregoing structural elements according to a provided form. Since the structural elements can be variously modified according to a convergence trend of a digital device, all elements cannot be described. Structural elements equivalent to the foregoing structural elements can be included in the portable terminal. In the portable terminal of the present invention, specific elements can be excluded from the foregoing structural elements according to a providing form or substituted by other elements. This will be easily appreciated by a person having ordinary skill in the art.

Furthermore, the portable terminal according to an embodiment of the present invention may include a device of all forms providing a specific list. For example, the portable terminal may include all kinds of information and communication devices and multi-media devices such as Portable Multimedia Player (PMP), digital broadcast player, Personal Digital Assistant (PDA), music player (e.g., MP3 player), portable game terminal, wired and wireless telephone, Smart Phone, and applications thereof as well as all mobile communication terminals operating based on communication protocols corresponding to various communication systems.

A control operation according to a function operation of the present invention in a portable terminal according to an embodiment of the present invention has been described. Hereinafter, examples of an operation screen according to the function operation will be described with reference to FIGS. 3 to 6. However, since examples of an operation screen according to the present invention is not limited to following contents, it should be noticed that they are applicable to various embodiments based on following embodiments.

FIG. 4 illustrates an example screen corresponding to a pop-up function execution in a portable terminal according to an embodiment of the present invention.

Referring to FIGS. 3 and 4, a controller 350 of the portable terminal can control display of a list screen of a specific category corresponding to a user request by the display unit as illustrated in reference numeral 410. The user operates the portable terminal to generate an input signal so that a screen of a desired list is displayed on the display unit 320. Accordingly, the controller 350 controls the display unit 320 to display a screen of a corresponding list like reference numeral 410 corresponding to the input signal. The list may be a list of a specific category including at least one object with output information such as a call log list, a message list, and a phone book list.

The list screen can be composed of a category area 401 providing category information belonging to a list displayed on the display unit 320, an object area 403 providing at least one object constituting the list, and a soft key area 405 executing various functions such as selection of the at least one object, entering lower menu, option menu activation. Here, the soft key area 405 can be omitted according to a user set or a provided form of the portable terminal.

Meanwhile, a screen example of reference numeral 410 is a screen that does not focus any objects upon providing an initial list. Upon providing the initial list, when focusing is automatically performed, the controller 350 may automatically designate and display focusing at an upper most object of the objects constituting the list upon providing the list. The example of the screen can be illustrated like a screen of reference numeral 420.

Next, the controller 350 can control focusing generation and focusing movement corresponding to a user's navigation execution achieved between objects in the list. That is, reference numeral 420 indicates a screen example focusing the upper most object, as illustrated in reference numeral 407, when initial navigation is performed in a screen example of reference numeral 410 according to a user request. The reference numeral 430 indicates a screen example when focusing moves in the screen example of reference numeral 420 as illustrated in reference numeral 409 corresponding to the user's navigation execution.

Referring to screen examples of reference numerals 420 and 430, the user may operate the portable terminal to perform an operation displaying focusing at a specific object on the list screen. Here, the operation may be an operation generating an input signal using an input unit 310 of the portable terminal or an operation generating a touch signal using a touch screen when the display unit 320 is configured by the touch screen. Accordingly, the controller 350 controls focusing of the specific object corresponding to an input signal or a touch signal generated according to the user operation.

Meanwhile, the controller 350 may analyze a type of a corresponding object when the specific object is focused as in the screen examples of reference numerals 420 and 430. For example, the controller 350 can check whether a corresponding focused object is an object (object of message type) with output information. At this time, when the categories of the list is included in a message list or a phone book list, a procedure analyzing the type of the object can be omitted.

Next, when the corresponding focused object does not contain output information according to the analysis of object type, the controller 350 may control set operation execution as illustrated in block 231 with reference to FIG. 2. Alternatively, when the corresponding focused object contains output information according to the type analysis of an object, the controller 350 may control set operation execution as illustrated in blocks 213 to 219 with reference to FIG. 2. For example, when a focused object of reference numeral 409 contains given output information as illustrated in a screen example of reference numeral 430, the controller 350 controls an output of the pop-up window 411 at a lower area of the focused object. Furthermore, the controller 530 controls an output of the output information 413 through the output pop-up window 411. In this case, the controller 350 may determine a pop-up area outputting the pop-up window 411. A screen example of reference numeral 430 indicates an example when the controller 350 determines a lower area of the object as the pop-up area.

Meanwhile, when an input signal or a touch signal is not generated from a user for a longer time than a given value in a screen example like reference numeral 430, the controller 350 may remove the pop-up window 411 from the display unit 320 like the screen example of reference numeral 440. In this case, the removal of the pop-up window 411 can be performed according to a set input signal. For example, a user may remove the pop-up window 411 by generating a touch screen using a touch screen or by generating an input signal using the input unit 310.

If a user's navigation is performed in a state of the reference numeral 430 or reference numeral 440, the controller 350 may continuously perform an operation of analyzing a type of an object and controlling an output of a pop-up window corresponding to an advance direction of the navigation.

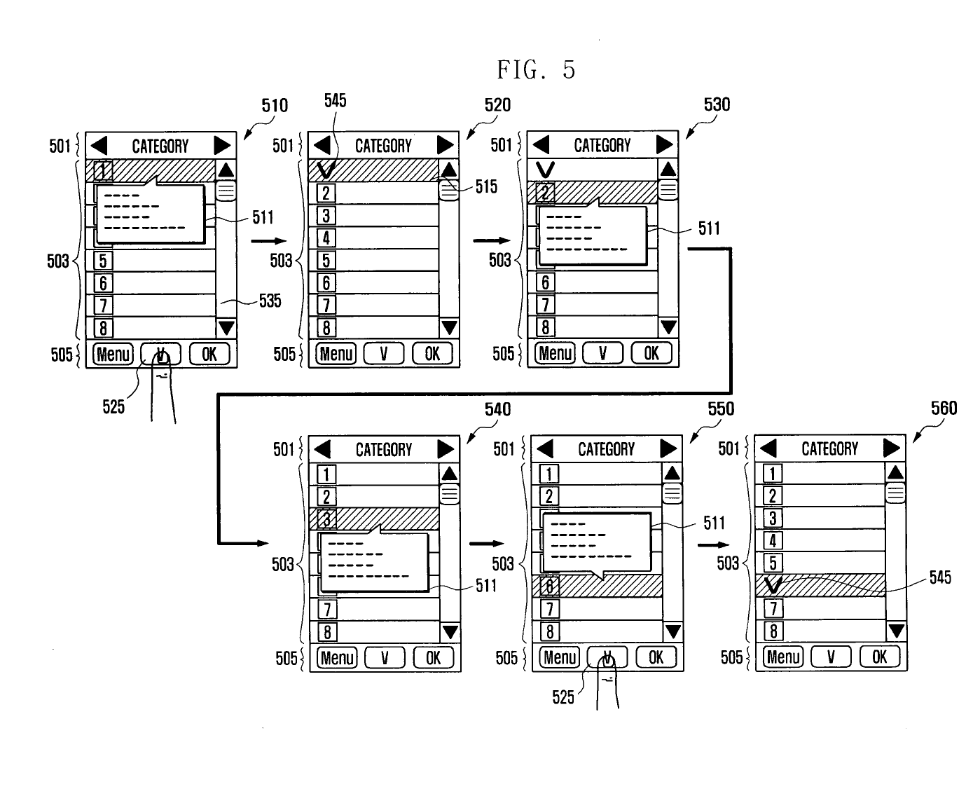

FIG. 5 illustrates examples of a screen corresponding to a pop-up function execution in a portable terminal according to an exemplary embodiment of the present invention.

Referring to FIGS. 3 and 5, a controller 350 of the portable terminal may display a list screen of a category corresponding to a user request on the display unit 320 as illustrated in reference numeral 510. For example, a user operates the portable terminal to generate an input signal for displaying a screen of a desired screen on the display unit 320. Accordingly, the controller 550 controls the display unit 320 to display a screen of a corresponding list on the display unit 320 as illustrated in reference numeral 510. The list screen can be composed of a category area 501 providing category information belonging to a list displayed on the display unit 320, an object area 503 providing at least one object constituting the list, and a soft key area 505 executing various functions such as selection of the at least one object, entering lower menu, option menu activation. Here, the soft key area 505 can be omitted according to a user set or a provided form of the portable terminal.

Meanwhile, a screen example of reference numeral 510 indicates an example when focusing is automatically created at an uppermost object (object of first item) of objects in the list upon providing an initial list. Accordingly, the controller 350 may analyze an uppermost object in the list upon providing the list screen to check whether it includes output information. At this time, when the list is a list with all objects including respective output information like a message list or a phone book list, a procedure of analyzing the object and checking presence of inclusion of the output information can be omitted.

Further, as the uppermost object (object of first item) is focused, the controller 350 may determine output information extraction and a pop-up area with respect to the object. Next, the controller 350 may output a pop-up window 511 at the determined pop-up area, and control output of the output information of the object through the pop-up window 511. For example, the controller 350 checks position information of the object on the list screen to determine a pop-up area corresponding to the position information. A screen example of reference numeral 510 indicates an example when a lower area neighboring the object is determined as the pop-up area.

Next, a user may generate an input signal selecting the focused object of a first item in a state like reference numeral 510. For example, the user can generate an input signal for selecting a selection key 525 to which a key instructing selection of an object in the soft key area 503 is allotted. When the display unit 320 is configured by a touch screen, the input signal is a touch signal generated by input touching the selection key 525 or an input signal generated by an input of a function key corresponding to the selection key 525 in the input unit 310.

Accordingly, the controller 350 may select an object of a first item corresponding to the input signal, and provide the selected object to distinguish from other non-selected objects. For example, the controller 350 can provide a selection item 545 indicating that a corresponding object is selected like “V” at one area (for example, left most area) of the first item as illustrated in a screen example of reference numeral 520. At this time, the controller 350 may control removal of the pop-up window 511 corresponding to the input signal.

Next, the user may perform navigation for confirming and selecting output information of another object in a state of reference numeral 530. Accordingly, the controller 350 may control the movement of focusing provided at an object of a first item corresponding to a user navigation operation achieved between objects in the list. At this time, the focusing can move corresponding to an advance direction of navigation according to the user request, and FIG. 5 shows an example when the focusing moves to a downward direction. Accordingly, the controller 350 may control moving of the focusing to the downward direction in response to a navigation operation to the lower direction. These examples indicate reference numerals 530 and 540, respectively.

As illustrated in a screen example of the reference numeral 530, the controller 350 controls the focusing movement. Furthermore, the controller 350 determines output information extraction and a pop-up area with respect to a corresponding object (object of a second item) focused according to the focusing movement. Next, the controller 350 outputs a pop-up window 511 at the determined pop-up area, and controls output of output information with respect to an object of the second item through the pop-up window 511. As illustrated in a screen example of reference numeral 540, the controller 350 controls movement of focusing provided to the object of the second item to an object of a third item according to the user navigation execution. Moreover, the controller 350 determines output information extraction and a pop-up area with respect to an object of a third item focused according to the focusing movement. Next, the controller 350 outputs a pop-up window 511 at the determined pop-up area, and controls output of output information with respect to an object of the third item through the pop-up window 511.

Next, the controller 350 can control navigation and a pop-up function to an object of a sixth item in the list according to the foregoing procedure as illustrated in a screen example of reference numeral 550. In addition, the controller 350 may determine output information extraction and a pop-up area with respect to an object of a sixth item when the object of a sixth item is focused. Next, the controller 350 may output a pop-up window 511 at the determined pop-up area, and control output of output information with respect to the object of a sixth item.

For example, the controller 350 checks position information of the object of the sixth item on the list screen to determine a pop-up area corresponding to the position information. A screen example of reference numeral 550 indicates an example when an upper area neighboring the object is determined as the pop-up area. As described above, the controller 350 may check a rate of a blank according to a position of the current focused object on the list screen, and determine a pop-up area outputting the pop-up window 511 corresponding thereto.

Next, the user may create an input signal selecting an object of the sixth item in a state of reference numeral 550. For example, the user can perform the selection procedure by generating an input signal using the input unit 310 or a touch signal using a touch screen constituting the display unit 320. Accordingly, the controller 350 may select an object of the sixth item corresponding to an input signal and provide the selected object to distinguish from other non-selected objects. For example, the controller 350 can provide a selection item 545 indicating that a corresponding object is selected like “V” at one area (for example, leftmost area) of the sixth item as illustrated in a screen example of reference numeral 550. At this time, the controller 350 can maintain the selection item 545 with respect to both of the object of the first item and the object of the sixth item. Furthermore, the controller 350 may control removal of the pop-up window 511 according to the input signal.

As described above, the user may perform navigation from the object of the third item to the object of the sixth item by repeating the foregoing operation. Accordingly, the user may omit an execution procedure such as a function execution for confirming contents of a corresponding object to confirm output information included in each object of the list, and cancellation of the execution function changing to the list screen. Accordingly, a user may rapidly perform navigation to an object of the sixth item and a selection procedure with respect to a desired object. Next, the user may execute functions such as deletion, movement, copy, protection function set with respect to the selected objects.

As mentioned above, in a list providing method and an apparatus thereof using a pop-up function according an embodiment of the present invention, it can check output information with respect to respective objects in the list in a real-time manner while performing navigation. Accordingly, for example, upon wanting to remove an object with unnecessary output information (message contents) in a message list, the user may selectively remove at least one desired object simply and rapidly while confirming corresponding output information of respective objects. That is, the present invention provides objects in a list together with output information through a pop-up window, and provide corresponding output information with respect to respective objects through a pop-up window in a real-time manner so that convenience for a user according to the management of lists can be enhanced.

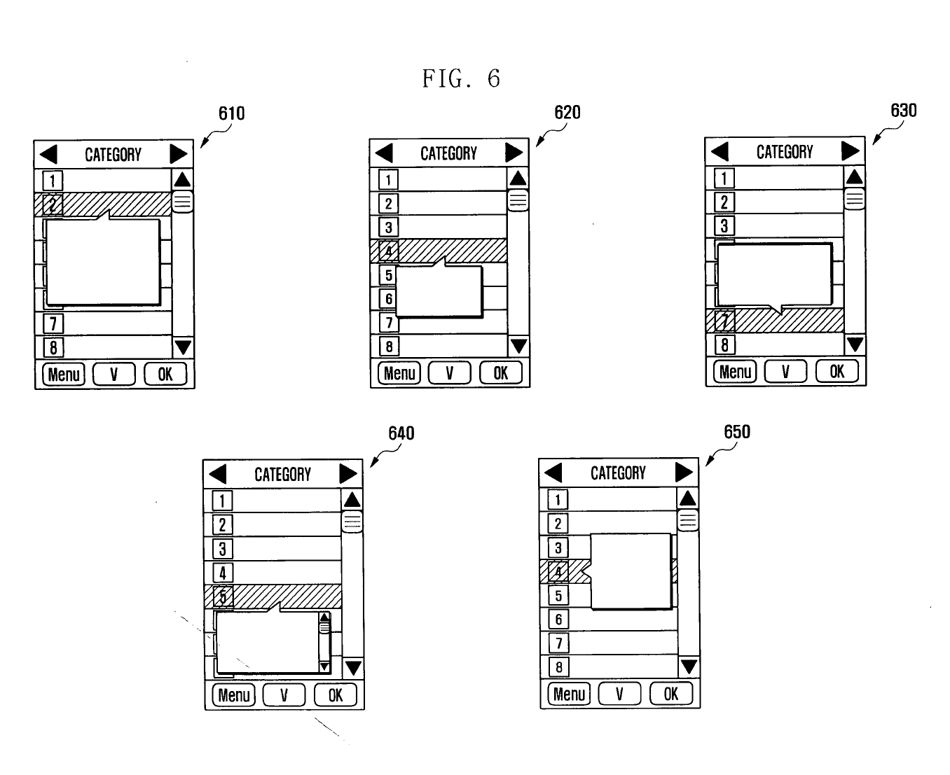

FIG. 6 illustrates a pop-up window provided from a portable terminal according to another exemplary embodiment of the present invention.

Referring to FIG. 6, an embodiment of the present invention may provide a pop-up window at an upper area or a lower area neighboring a corresponding object according to a position of the corresponding object on a list screen as illustrated in screen examples of reference numeral 610 to reference numeral 640. Otherwise, as illustrated in a screen example of reference numeral 650, a corresponding object can be provided at a left area or a right area in an overlapped form with a corresponding object according to the position of the corresponding object on the list screen.

Furthermore, the pop-up window can be provided with various sizes according to the size of output information included in the focused object as illustrated in screen examples of reference numerals 610 and 620. Namely, the pop-up window can be provided with a maximum size or a minimum size capable of displaying the output information. Moreover, as illustrated in reference numeral 650, the pop-up window can be provided to include a scroll bar according to the size of the output information.

Accordingly, a controller 350 of the portable terminal may determine a pop-up area of a pop-up window according to a position of a corresponding object on a list screen upon controlling a pop-up function according to the present invention. Upon outputting the pop-up window, a shape of the pop-up window can be adjusted to the size corresponding to that of the output information. Further, the controller 350 may provide a scroll bar to one area of the pop-up window according to the size of output information and a maximum size.

Meanwhile, navigation control and pop-up function control in the portable terminal according to an embodiment of the present invention are performed by generating an input signal using the input unit or a display unit 320 with a touch screen as a representative example. However, in an embodiment of the present invention, the navigation control and the pop-up function control can be achieved by a microphone MIC, a motion sensor, or an acceleration sensor.

Namely, the controller 350 of the portable terminal can control focusing movement command and selection command by a voice recognition function and a motion recognition function. For example, in a state that a specific list screen is provided, a user can send a navigation command between objects in a list by voice recognition such as “upward movement” or “downward movement” or motion recognition such as “downward tilt” or “upward tilt” of the portable terminal.

Accordingly, the portable terminal may move, display, and control a focusing state in respective objects in the list corresponding to the navigation command. Further, in a state that the specific list screen is provided, a user can send a selection command selecting a focused object by voice recognition such as “selection” or motion recognition by set motion of the portable terminal. Accordingly, the portable terminal may select a corresponding object focused corresponding to the selection command and control display of an item corresponding thereto.

As mentioned above, in a method for providing a list in a portable terminal using a pop-up function, and an apparatus thereof according to the present invention, a list can be managed and supported simply and rapidly using the pop-up function. In the present invention, a user can check output information with respect to respective objects in the list in a real-time manner while performing navigation. Accordingly, a user can manage a list while checking output information with respect to a corresponding object from a list in a real-time manner. Accordingly, the user can rapidly determine whether to delete, move, copy, or maintain objects in the list.

For example, when the user wants to remove an object with unnecessary output information (message contents) form a message list, the user can determine to remove at least one desired object simply and rapidly while checking corresponding output information of respective objects in a real-time manner. Namely, in the present invention, objects in the list is provided together with output information through a pop-up window, and corresponding output information with respect to respective objects is provided in a real-time manner, with the result that convenience for users can be improved.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, and the like, that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A list providing method, comprising:
outputting a list screen composed of a plurality of objects;
extracting output information of a specific object focused among the objects; and
displaying the output information of the focused specific object on a pop-up window of the list screen.

2. The method of claim 1, wherein extracting output information comprises determining a pop-up area of the pop-up window to output the extracted output information.

3. The method of claim 2, wherein determining a pop-up area determines one of an upper area, a lower area, a left area, and a right area neighboring the focused specific object according to a location of the specific focused object.

4. The method of claim 3, wherein displaying the output information comprises:
outputting the pop-up window in the determined pop-up area; and
outputting the output information on the output pop-up window.

5. The method of claim 4, wherein outputting the pop-up window outputs the pop-up window with a size corresponding to that of the output information.

6. The method of claim 1, wherein extracting output information comprises:
analyzing a type of the focused specific object; and
extracting the output information when the type of the focused specific object is a given type of an object.

7. The method of claim 6, further comprising:
moving the focusing in response to a moving request of the focusing;
determining output information extraction and a pop-up area of an object focused by the focusing movement;
outputting a pop-up window in the determined pop-up area; and
outputting the output information through the pop-up window.

8. The method of claim 5, further comprising providing a scroll bar for scroll of the output information upon outputting the pop-up window.

9. A portable terminal comprising:
a display unit configured to display a list comprising a plurality of objects, a focusing state of a specific object in the list, and output information of a focused object through a pop-up window; and
a controller configured to focus an object in the list, determine extraction of the output information of the focused object and a pop-up area of the pop-up window, and control an output of the pop-up window with the output information to the determined pop-up area.

10. The portable terminal of claim 9, wherein the controller is configured to control output of the pop-up window with a size corresponding to that of the output information.

11. The portable terminal of claim 10, wherein the controller is configured to determine one of an upper area, a lower area, a left area, and a right area neighboring the focused specific object according to a location of the focused specific object.

12. The portable terminal of claim 10, wherein the pop-up window comprises a scroll bar for scroll of the output information.

13. The portable terminal of claim 10, wherein the controller is configured to control simultaneous display of the plurality of objects and the output information on the list screen.

14. The portable terminal of claim 9, wherein the controller is configured to analyze a type of the focused object, and determine extraction of the output information and a pop-up area when the type of the focused object is a given type of an object.

15. The portable terminal of claim 9, wherein the portable terminal comprises:
at least one of: an input unit and a touch screen generating a focusing movement input signal and an object selection input signal; and
a controller configured to focus movement according to the focusing movement input signal, a pop-up function of output information with respect to an object focused according to the focusing movement, and selection item display of an object selected according to the object selection input signal.

16. A controller for use in a portable terminal, the controller configured to:
cause a display unit to display a list comprising a plurality of objects, a focusing state of a specific object in the list, and output information of a focused object through a pop-up window; and
focus an object in the list, determine extraction of the output information of the focused object and a pop-up area of the pop-up window, and control an output of the pop-up window with the output information to the determined pop-up area.

17. The controller of claim 16, wherein the controller is configured to control output of the pop-up window with a size corresponding to that of the output information, wherein the pop-up window comprises a scroll bar for scroll of the output information.

18. The controller of claim 17, wherein the controller is configured to control simultaneous display of the plurality of objects and the output information on the list screen.

19. The controller of claim 16, wherein the controller is configured to analyze a type of the focused object, and determine extraction of the output information and a pop-up area when the type of the focused object is a given type of an object.

20. The controller of claim 16, wherein the controller is configured to receive an input via an input unit, wherein the input unit comprises: at least one of: an input unit and a touch screen generating a focusing movement input signal and an object selection input signal; and wherein a controller configured to focus movement according to the focusing movement input signal, a pop-up function of output information with respect to an object focused according to the focusing movement, and selection item display of an object selected according to the object selection input signal.
